(19) United States
(12) Patent Application Publication
(10) Pub. No.: US 2011/0102940 A1
(43) Pub. Date: May 5, 2011

(54) SYSTEM, METHOD AND APPARATUS FOR PLANARIZING SURFACES WITH FUNCTIONALIZED POLYMERS

(75) Inventors: Joan K. Bosworth, San Jose, CA (US); Charles M. Mate, San Jose, CA (US); Ricardo Ruiz, San Bruno, CA (US)

(73) Assignee: Hitachi Global Storage Technologies Netherlands B.V., Amsterdam (NL)

(21) Appl. No.: 12/610,461

(22) Filed: Nov. 2, 2009

(51) Int. Cl. G11B 5/23; G11B 5/187

(52) U.S. Cl. 360/119.01; 216/22; G9B/5.06

(57) ABSTRACT

The surfaces of hard disk drive magnetic media disks are planarized with surface-grafted polymer chains that form a monolayer-thick film of uniform, self-limiting thickness. The thickness is controlled by the molecular weight of the polymer selected. The polymer film may be swollen by a solvent vapor to fill variable width gaps in the topography. The polymer may be cross-linked in place by radiation or thermal processing.

### BACKGROUND

1. Field of Disclosure

The invention is generally related to hard disk drives and, in particular, to an improved system, method and apparatus for planarized surfaces on magnetic media disks for hard disk drives.

2. Description of Related Art

A magnetic media storage disk for a hard disk drive (HDD) requires a very flat surface to achieve optimal lift from the air bearing generated by flying the head slider over the disk surface. In particular, an ultra-flat disk surface helps maintain a constant flying height of the read and write elements of the slider relative to the disk. Planarity minimizes fluctuations in the magnetic spacing between the disk and the magnetic elements in the slider and thereby yields more consistent performance.

Both discrete track media (DTM) and bit patterned media (BPM) are future magnetic recording technologies for HDDs that involve non-planar disk surface topographies. These technologies will require enhanced surface planarization techniques to achieve constant flying heights. In DTM, the individual data tracks are physically patterned on the disk. With BPM, the individual bits are physically patterned resulting in nanometer-scale gaps, trenches and grooves between the data tracks or data bits. A suitable disk surface planarization technique is needed to fill in such topographic gaps. Improved planarization provides adequate support to the air bearing surface without compromising the magnetic spacing.

Conventional polymer-based planarization methods typically involve the techniques of dip coating or nano-imprint planarization. The dip coating technique relies on capillary action to fill in the gaps between the media elements. This process is generally limited by the formation of meniscus features of finite curvature, which may not comply with planarization specifications. Dip coating also faces challenges when attempting to fill gaps of various dimensions on the same disk.

The nano-imprint planarization process, on the other hand, faces film uniformity challenges. The nano-imprint process leaves a residual layer with a thickness that varies across the disk. This residual layer is etched away in a subsequent step, but a final planar surface can result only if the original residual layer is of uniform thickness. Nano-imprint planarization also faces economic limitations to be implemented in a manufacturing line because of the elevated cost of imprinting tools. Thus, an improved solution for planarizing the surfaces of magnetic media disks would be desirable.

### SUMMARY OF THE INVENTION

Embodiments of a system, method and apparatus for planarized surfaces on magnetic media disks for hard disk drives are disclosed. Some embodiments use surface-grafted polymer chains that form a monolayer-thick film of uniform, self-limiting thickness to planarize the surface of the disk.

For example, the film may be formed by grafting the polymer to the surface, or growing the polymer from the surface. The film may be grafted to the disk with a functionalized polymer chain having a radical group that binds to the surface of the disk. This technique forms a monolayer film of uniform, self-limiting thickness. In an alternate embodiment, the technique involves surface-initiated polymerization that grows the polymer from the disk and also forms a monolayer film of uniform thickness.

The thickness of the polymer monolayer may be controlled by selection of the molecular weight of the polymer. If the gap or trench in the disk to be planarized is on the order of twice the thickness of the polymer monolayer, the conformal polymer layer fills in the gap to planarize the surface. This planarization process does not rely on capillary action (i.e., it has no meniscus profile). The film thickness is self-limiting to a single molecular layer, resulting in a uniform thickness over the disk. However, some trenches and gaps in disks have a variable width or non-uniform gaps. For these disks, the polymer film may be swollen by a solvent vapor to fill the variable width gaps. The polymer is then cross-linked in place by radiation or thermal processing.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIG. 1 depicts top and enlarged top views of a media disk the schematically illustrates bit patterned media and discrete track media;

FIG. 2 is a schematic sectional side view of the media of FIG. 1, taken along the line 2-2 of FIG. 1;

FIGS. 3A-C are schematic, sequential sectional side views of one embodiment of a process for planarizing the surface of media disk in accordance with the invention;

FIGS. 4A-D are schematic, sequential sectional side views of another embodiment of a process for planarizing the surface of media disk in accordance with the invention;

FIGS. 5A-C are schematic, sequential sectional side views of still another embodiment of a process for planarizing the surface of media disk in accordance with the invention; and

FIGS. 6A-C are schematic, sequential sectional side views of yet another embodiment of a process for planarizing the surface of media disk in accordance with the invention; and

FIG. 7 is a schematic view of a disk drive constructed in accordance with the invention.

The use of the same reference symbols in different drawings indicates similar or identical items.

### DETAILED DESCRIPTION OF THE INVENTION

FIGS. 1-6 depict embodiments of an improved system, method and apparatus for planarized surfaces on magnetic media disks for hard disk drives. Embodiments of the present invention use functionalized polymer chains for surface planarization to improve planarity of the disk with minimal additional thickness.

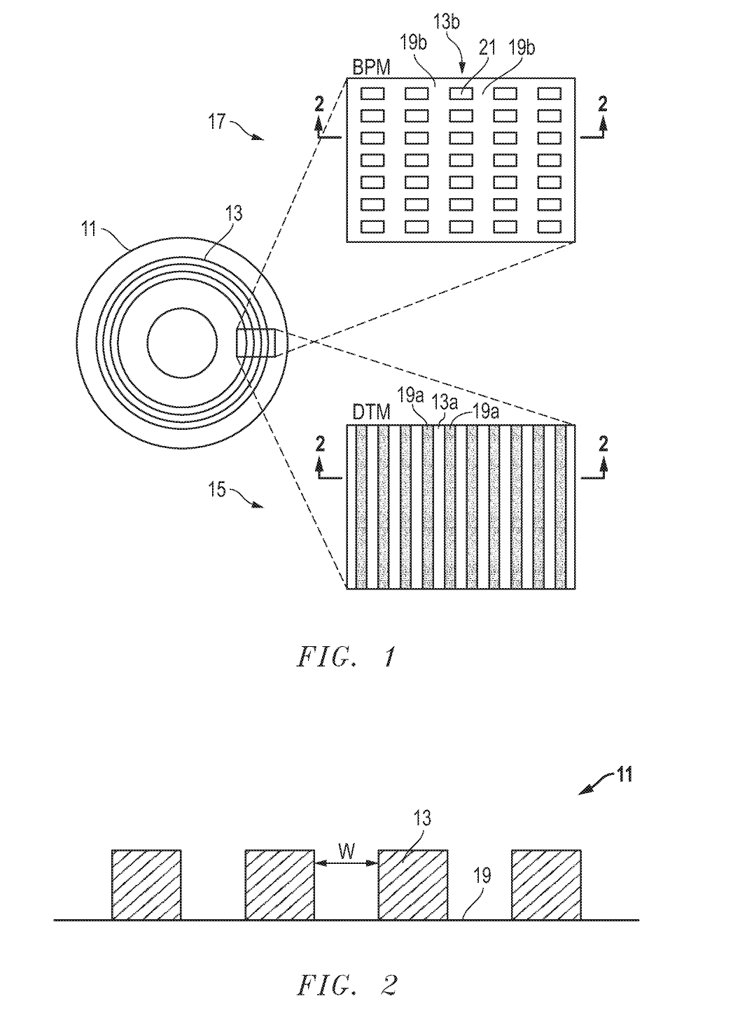

FIGS. 1 and 2 schematically illustrate a magnetic media disk 11 having concentric data tracks 13. FIG. 1 also discloses structural examples of discrete track media (DTM) 15 and bit patterned media (BPM) 17. In DTM 15, the patterned disk 11 contains data tracks 13a that are isolated from each other by grooves 19. In BPM 17, the individual bits form rows 13b of nanometer-scale pillars 21 that are separated from one another (e.g., horizontally in FIG. 1) by radial trenches or gaps 19b of width “w.” The pillars 21 in each row 13b are also separated from each other longitudinally (e.g., vertically in FIG. 1). This geometry gives the data media of BPM less surface area than that of DTM. Embodiments are disclosed for planarizing the grooves or trenches 19 (FIG. 2) with the data tracks 13 of both types of media.

For surface planarization, embodiments of functionalized polymer chains contain a radical group for grafting the polymer to the surface of the disk. For example, some embodiments use polymers such as functionalized polystyrene (e.g., hydroxyl-terminated polystyrene chains), polymethyl methacrylate, polyethylene, polyethylene oxide, poly dimethylsiloxane, or poly dihydroxybenzyl alcohol may be used. In other embodiments, the functional group may comprise a hydroxyl group, carboxilic group, thiol or methyl ester. The polymer also may comprise a dendrimeric structure and at least one functional group, or a perfluoropolyether.

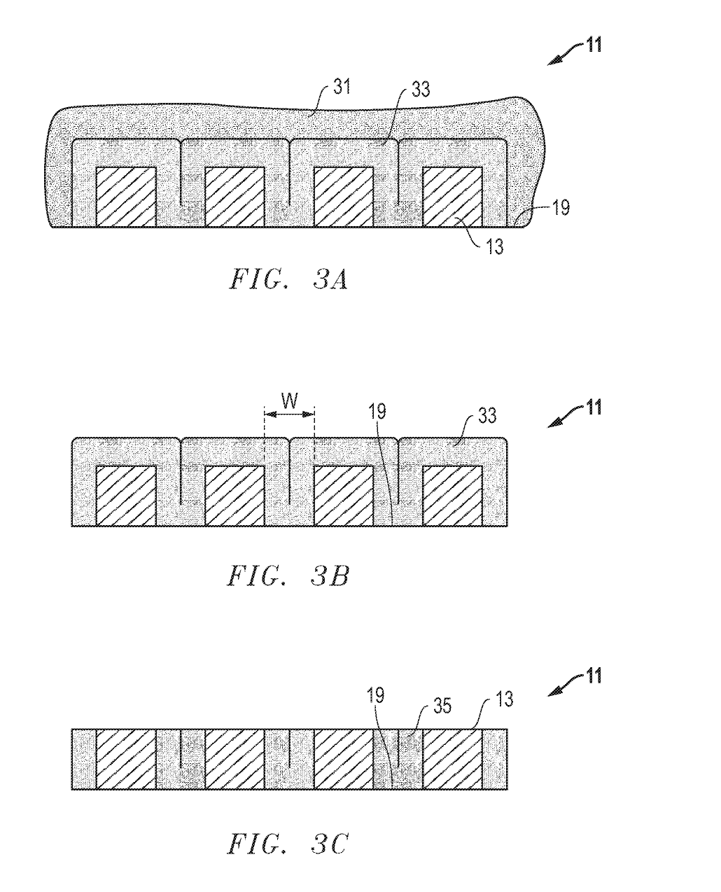

In some embodiments (see, e.g., FIG. 3A), a solution 31 containing the functionalized polymer is used to deposit a film on the surface of the disk 11 by, e.g., spin coating or dip casting. Depending on the application, the film may be subjected to thermal annealing for the functional group to bind to the surface. In a subsequent step (see, e.g., FIG. 3B), any excess material above the first monolayer of the solution that is not bound to the surface is removed by rinsing with a suitable solvent. For example, toluene or PGMEA may be used for a polymer comprising polystyrene.

After rinsing, only the first monolayer 33 bound to the surface remains, leaving a film of uniform thickness. For example, the length of the polymer chain may be chosen such that the thickness of the first monolayer is on the order of about half the gap width “w” in the trenches 19 being planarized. When a monolayer forms on both sides of the trench 19, the film closes the gap to planarize the surface as shown in FIG. 3B. In FIG. 3C, a material removal process such as reactive ion etching (RIE) is used to remove the top part of the polymer film until the original top surface of the disk is exposed. Thus, as shown in FIG. 3C, the process for installing the monolayer on the side surfaces of the data tracks 13 makes the film 35 flush with the top surfaces of the data tracks 13.

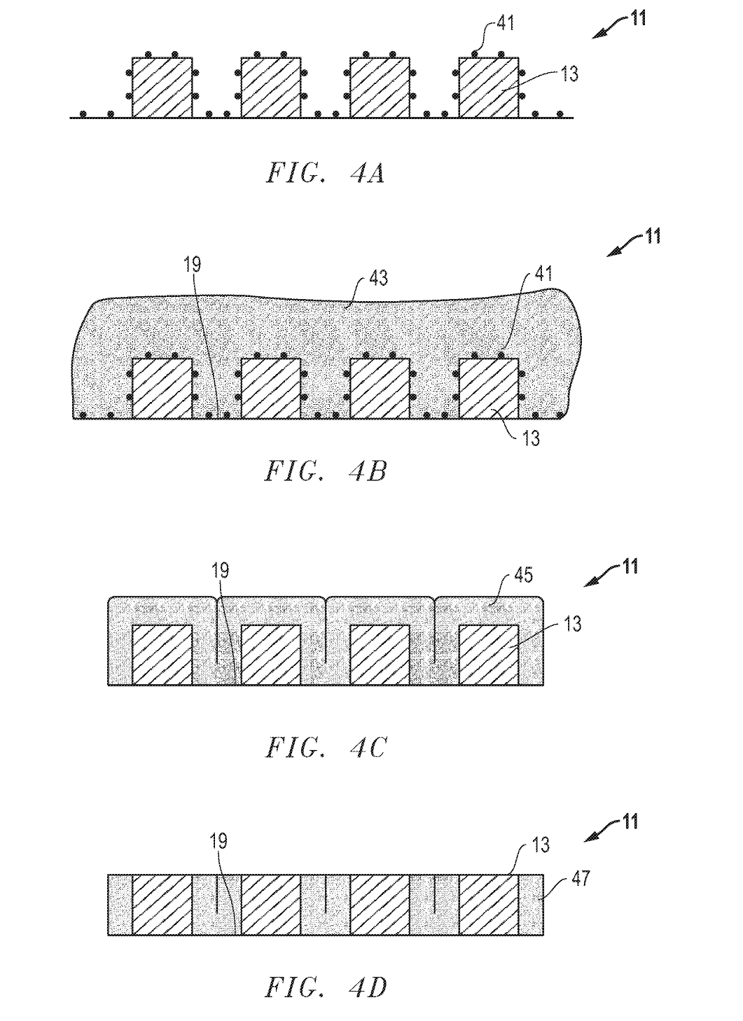

In alternate embodiments (see, e.g., FIG. 4), the polymer may be grown directly on the disk surface to form a planarized polymer layer. For example, the polymer may be grown from a functionalized surface by living surface polymerization, such as atom transfer radical polymerization (ATRP), or nitroxide-mediated radical polymerization (NMRP).

As shown in FIG. 4A, the surface of disk 11 may be provided with an initiator 41. Initiator 41 may be an inherent material of the disk (e.g., a functionalized lubricant), or deposited on its surface (e.g., a functionalized self-assembling monolayer (SAM). The disk is then exposed to a monomer precursor 43 (FIG. 4B) for a selected period of time to grow the polymer directly on the disk surface based on a chemical reaction between the initiator 41 and precursor 43. Removal of the precursor (FIG. 4C) leaves polymer film 45 on the disk surface. The resultant single polymer layers 45 can then be etched 47 (FIG. 4D) until the disk surface is flush and exposed as described herein. Examples of initiators and precursors include brominated SAM for ATRP, and nitroxide-functionalized SAM for NMRP.

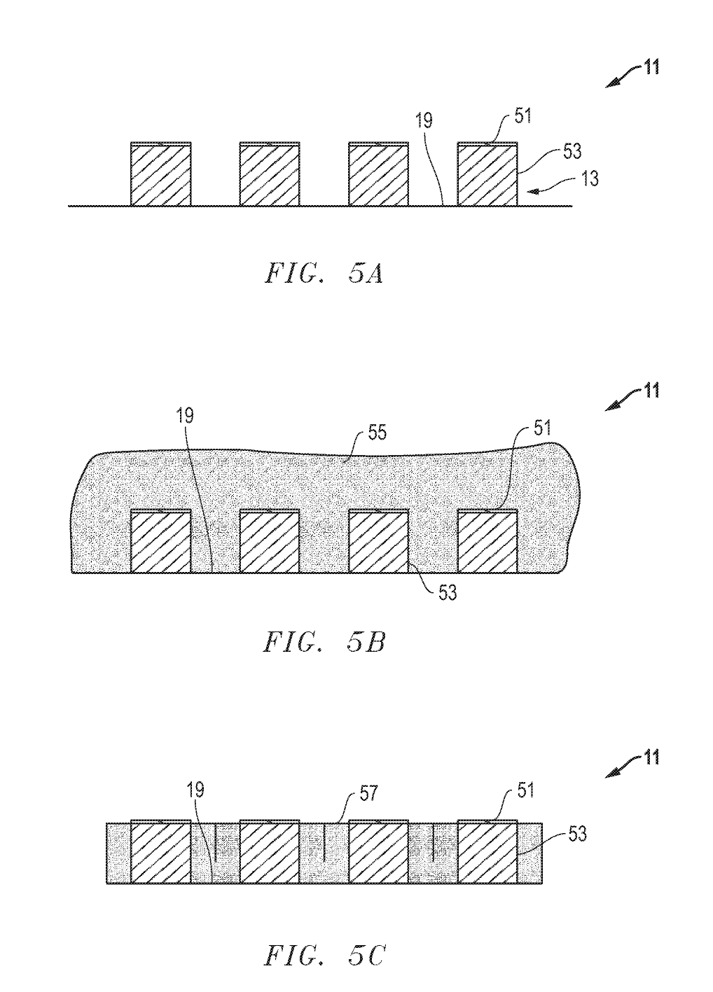

In still other embodiments (see, e.g., FIG. 5A), the surface of disk 11 has data tracks 13 that are formed with a first material 51 (shown exaggerated) on the top surfaces, and a second material 53 on the side walls of the trenches 19. With this version, the functional group of the polymer solution 55 (FIG. 5B) grafts only to the walls, but not to the tops. The disk is planarized after rinsing the excess material that is not bound to the surface. With some techniques, the polymerization initiator is bound only to the trench walls. Thus, polymerization occurs only within the trench walls, and not on the top surfaces to form a substantially flush disk surface with film 57 (FIG. 5C). These embodiments avoid the use of the material removal or etching step.

These embodiments are generally fabricated by one of two processes for BPM and DTM. In the first type of process (hereinafter referred to as “post-etched media”), the layers that form the magnetic recording media are deposited first on a flat substrate and subsequently milled or etched to form the grooves and trenches that define tracks for DTM or bits for BPM. In this first process, the overcoat or top layer may be chosen as the first material 51, to which the functional groups of the planarizing polymer do not react.

In a second type of process (hereinafter referred to as “pre-patterned substrate”), the substrate is textured first with the lands and grooves that form the DTM or BPM structures, followed by a subsequent deposition of the materials that form the magnetic recording media. In the “pre-patterned” substrate, both lands and grooves are covered by the same materials. A different top layer 51 is then deposited by a grazing angle deposition (e.g., evaporation, e-beam evaporation, ion beam deposition, sputtering, etc.) where the deposited species arrive at a shallow angle with respect to the substrate. In this technique the material is deposited only on the top of the “lands” but not in the “grooves.”

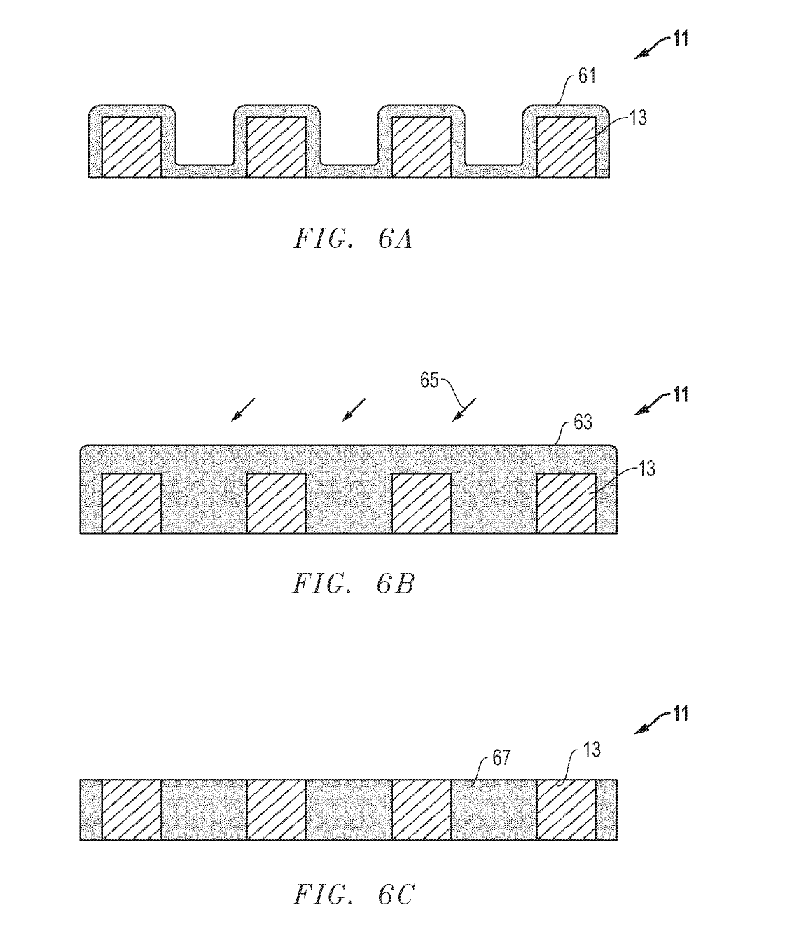

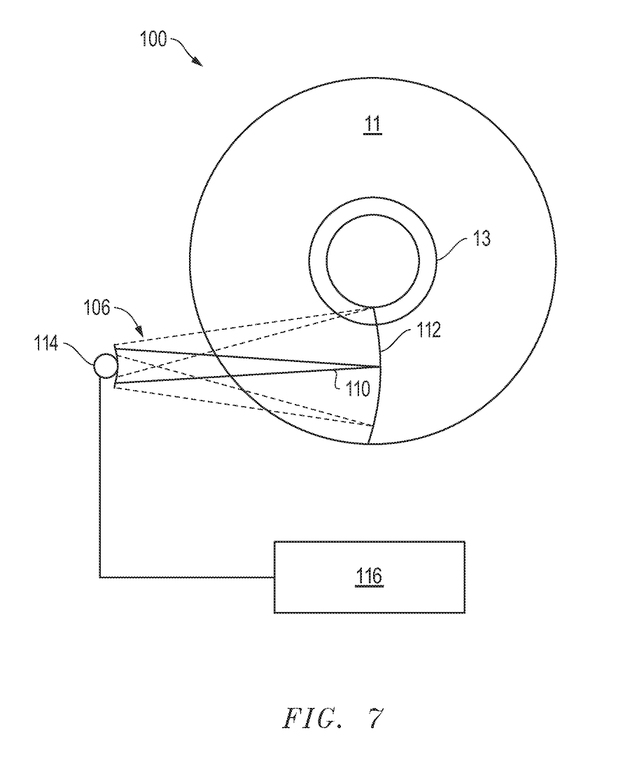

In some applications, the disk surface has gaps that are not all identical in width. In other applications (see, e.g., FIG. 6), the width of the trench 19 may be much larger (e.g., twice as large) as the monolayer thickness of the polymer. In some embodiments, the polymer may be grafted to the disk as described herein up to the rinsing step (see, e.g., FIGS. 3B, 4C) where the excess material is rinsed away to leave a monolayer-thick film 61, as depicted in FIG. 6A.

The polymer film is subsequently swollen (FIG. 6B) by solvent annealing or a similar method where the sample is exposed to a controlled atmosphere containing a suitable solvent vapor to form the swollen polymer chains 63 (shown exaggerated). The swollen polymer 63 extends until the gaps 19 are closed and at least planarized. To fix the polymer in the swollen structure, the film is cross-linked 65 by radiation or by thermal cross-linking. After cross-linking, the disk is removed from the controlled atmosphere. A material removal process (FIG. 6C) such as reactive ion etching (RIE) follows to etch the top part of the polymer film until the original top surface of the disk is exposed and the remaining film 67 is flush with it. This same technique may be used for polymer layers created using the growth method (see, e.g., FIG. 4) described herein.

In solvent swelling or annealing in accordance with these embodiments, the solvent is chosen according to the polymer used and the desired degree of swelling. For example, for polystyrene polymer, the solvent may comprise toluene, propylene glycol monomethyl ether acetate (PGMEA) or other types of solvents.

The molecules utilized by the invention to form the polymer monolayers are much larger in size than those used in conventional planarizing materials. A portion of the polymer molecules reacts with the disk materials to form a permanent bond. It is only the functionalized portion of the polymer that reacts with and remains adhered to the disk.

Referring now to FIG. 7, a schematic diagram of a hard disk drive assembly 100 constructed in accordance with the invention is shown. A hard disk drive assembly 100 generally comprises one or more disks as described herein comprising the magnetic recording media 11, rotated at high speeds by a spindle motor (not shown) during operation. The concentric data tracks 13 are formed on either or both disk surfaces receive and store magnetic information.

A read/write head 110 may be moved across the disk surface by an actuator assembly 106, allowing the head 110 to read or write magnetic data to a particular track 13. The actuator assembly 106 may pivot on a pivot 114. The actuator assembly 106 may form part of a closed loop feedback system, known as servo control, which dynamically positions the read/write head 110 to compensate for thermal expansion of the magnetic recording media 11 as well as vibrations and other disturbances. Also involved in the servo control system is a complex computational algorithm executed by a microprocessor, digital signal processor, or analog signal processor 116 that receives data address information from an associated computer, converts it to a location on the magnetic recording media 11, and moves the read/write head 110 accordingly.

Specifically, read/write heads 110 periodically reference servo patterns recorded on the disk to ensure accurate head 110 positioning. Servo patterns may be used to ensure a read/write head 110 follows a particular track accurately, and to control and monitor transition of the head 110 from one track 13 to another. Upon referencing a servo pattern, the read/write head 110 obtains head position information that enables the control circuitry 116 to subsequently realign the head 110 to correct any detected error.

Servo patterns may be contained in engineered servo sectors 112 embedded within a plurality of data tracks 13 to allow frequent sampling of the servo patterns for optimum disk drive performance. In a typical magnetic recording media 11, embedded servo sectors 112 extend substantially radially from the center of the magnetic recording media 11, like spokes from the center of a wheel. Unlike spokes however, servo sectors 112 form a subtle, arc-shaped path calibrated to substantially match the range of motion of the read/write head 110.

Accordingly, some embodiments may comprise a hard disk drive having a planarized magnetic media disk having an axis and concentric data tracks of magnetic elements. The concentric data tracks are separated from each other by gaps. The magnetic elements have top surfaces and the gaps have a gap surface that is axially spaced apart from the top surfaces of the magnetic elements. The gaps are filled and planarization is achieved by a functionalized polymer such that the gaps are substantially flush with the top surfaces and the top surfaces are exposed. An actuator has a magnetic transducer for reading data from the magnetic media disk, and the actuator is movable relative to the magnetic media disk.

In other embodiments, each of the gaps has a width in a range of 1 to 100 nm. The functionalized polymer may form a monolayer film having a single molecular thickness in a range of 10% to 200% of the width of the gaps. The functionalized polymer may be a functionalized polystyrene, polymethyl methacrylate, polyethylene, polyethylene oxide, poly dimethylsiloxane, or poly dihydroxybenzyl alcohol, and the functional group may be a hydroxyl group, carboxilic group, or thiol and methyl ester. The functionalized polymer may have a dendrimeric structure and at least one functional group. At least a portion of the functionalized polymer may comprise a perfluoropolyether. The magnetic elements may comprise DTM and the gaps comprise grooves that isolate the DTM from each other. The magnetic elements also may be BPM having individual bits formed in rows of nanometer-scale pillars that are separated from one another by the gaps, and the pillars in each row also are separated from each other in a transverse direction.

In other embodiments, a method of planarizing the surface of a magnetic media disk comprises providing a patterned substrate having an axis and concentric data tracks of magnetic elements, the concentric data tracks being separated from each other by gaps, and the magnetic elements having top surfaces and the gaps having a gap surface that is axially spaced apart from the top surfaces of the magnetic elements; depositing a solution containing a functionalized polymer on the patterned substrate to form a film on the patterned substrate; removing any solution from the patterned substrate exceeding a first monolayer of the solution comprising a single molecular layer that is not bound to the patterned substrate, such that the film comprises a uniform thickness; and then removing (e.g., etching) a top portion of the film such that the gaps are filled by the functionalized polymer, the gaps are substantially flush with the top surfaces, and the top surfaces are exposed to planarize a surface of the patterned media.

In still other embodiments, the depositing step comprises spin coating or dip casting, and the removing step comprises rinsing with a solvent. A length of the polymer chain may be selected such that a thickness of the first monolayer is approximately half of a width of the gaps. The first monolayer may form on side walls of the magnetic elements to close the gaps between adjacent ones of the magnetic elements to planarize the surface of the patterned media. The method may further comprise, after the depositing step, subjecting the film to thermal annealing to bind the functional group to the patterned substrate. The etching may comprise reactive ion etching, and the functionalized polymer may be grown directly on the patterned substrate to form a planarized polymer layer.

In some embodiments, the gaps are not necessarily identical in width, and after the removing step the method may further comprise swelling the film to extend into and close the gaps; and cross-linking the film to fix the polymer in a swollen structure. The width of the gaps may be about twice as large as the monolayer thickness of the polymer, the film swollen by solvent annealing and exposing the patterned substrate to a controlled atmosphere containing a solvent vapor to form swollen polymer chains, and cross-linking by radiation or thermal cross-linking. The method also may further comprise removing the patterned substrate from a controlled atmosphere and performing the removal step. The swelling and cross-liking steps may planarize the surface of the patterned media such that no additional removal step is required.

In additional embodiments, the functionalized polymer is grown from a functionalized surface by atom transfer radical polymerization or nitroxide-mediated radical polymerization. The method may further comprise providing the surface of the patterned media with an initiator, exposing the patterned media to a precursor for a selected period of time to grow the functionalized polymer directly on the surface based on a chemical reaction between the initiator and the precursor, removing the precursor to form the film on the surface, and removing a portion of the film until the surface is planarized.

The initiator may be an inherent material of the patterned media, or deposited on the surface. The top surfaces of the magnetic elements may be formed from a first material, and side walls of the magnetic elements and the gaps formed from a second material, such that the functional group of the polymer grafts only to the side walls and gaps but not to the top surfaces to form the planarized surface without the removal step. In some embodiments, the planarized surface of the patterned media has a maximum variation of no more than 5 nm.

Applications for these embodiments may include the use of surface modification layers among various disciplines, ranging from organic or inorganic interfaces for electrical and optical devices, nanofabrication, MEMS, liquid crystals, templating of bio-structures and bio-inspired polymers, self-assembly, etc. As all these and other new disciplines require more complex structures at the nanometer scale, a planarization scheme combined with a surface modification layer may find applications beyond the scope of hard disk drives into these types of technologies.

This written description uses examples to disclose the invention, including the best mode, and also to enable those of ordinary skill in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A hard disk drive, comprising:
a magnetic media disk having an axis and concentric data tracks of magnetic elements, the concentric data tracks being separated from each other by gaps, the magnetic elements having top surfaces and the gaps having a gap surface that is axially spaced apart from the top surfaces of the magnetic elements, and the gaps are filled by a functionalized polymer such that the gaps are substantially flush with the top surfaces and the top surfaces are exposed; and
an actuator having a magnetic transducer for reading data from the magnetic media disk, the actuator being movable relative to the magnetic media disk.

2. A hard disk drive according to claim 1, wherein each of the gaps have a width in a range of 1 to 100 nm.

3. A hard disk drive according to claim 2, wherein the functionalized polymer forms a monolayer film having a single molecular thickness in a range of 10% to 200% of the width of the gaps.

4. A hard disk drive according to claim 1, wherein the functionalized polymer is one of a functionalized polystyrene, polymethyl methacrylate, polyethylene, polyethylene oxide, poly dimethylsiloxane, poly dihydroxybenzyl alcohol, and the functional group is one of a hydroxyl group, carboxilic group, thiol and methyl ester.

5. A hard disk drive according to claim 1, wherein the functionalized polymer has a dendrimeric structure and at least one functional group.

6. A hard disk drive according to claim 1, wherein at least a portion of the functionalized polymer comprises a perfluoropolyether.

7. A hard disk drive according to claim 1, wherein the magnetic elements are discrete track media (DTM) and the gaps comprise grooves that isolate the DTM from each other.

8. A hard disk drive according to claim 1, wherein the magnetic elements are bit patterned media having individual bits formed in rows of nanometer-scale pillars that are separated from one another by the gaps, and the pillars in each row also are separated from each other in a transverse direction.

9. A method of planarizing the surface of a magnetic media disk, comprising:
(a) providing a patterned substrate having an axis and concentric data tracks of magnetic elements, the concentric data tracks being separated from each other by gaps, and the magnetic elements having top surfaces and the gaps having a gap surface that is axially spaced apart from the top surfaces of the magnetic elements;
(b) depositing a solution containing a functionalized polymer on the patterned substrate to form a film on the patterned substrate;
(c) removing any solution from the patterned substrate exceeding a first monolayer of the solution comprising a single molecular layer that is not bound to the patterned substrate, such that the film comprises a uniform thickness; and then
(d) removing a top portion of the film such that the gaps are filled by the functionalized polymer, the gaps are substantially flush with the top surfaces, and the top surfaces are exposed to planarize a surface of the patterned media.

10. A method according to claim 9, wherein step (b) comprises spin coating or dip casting, and step (c) comprises rinsing with a solvent.

11. A method according to claim 9, wherein a length of the polymer chain is selected such that a thickness of the first monolayer is approximately half of a width of the gaps.

12. A method according to claim 9, wherein the first monolayer forms on side walls of the magnetic elements to close the gaps between adjacent ones of the magnetic elements to planarize the surface of the patterned media.

13. A method according to claim 9, further comprising, after step (b), subjecting the film to thermal annealing to bind the functional group to the patterned substrate.

14. A method according to claim 9, wherein the material removal process comprises reactive ion etching, and the functionalized polymer is grown directly on the patterned substrate to form a planarized polymer layer.

15. A method according to claim 9, wherein the gaps are not identical in width, and after step (c) further comprising:
swelling the film to extend into and close the gaps;
cross-linking the film to fix the polymer in a swollen structure; and wherein
the width of the gaps is about twice as large as the monolayer thickness of the polymer, the film is swollen by solvent annealing and exposing the patterned substrate to a controlled atmosphere containing a solvent vapor to form swollen polymer chains, and the cross-linking is by radiation or thermal cross-linking.

16. A method according to claim 15, further comprising removing the patterned substrate from a controlled atmosphere and performing the removal step, and wherein the swelling and cross-liking steps planarized the surface of the patterned media and no additional removal step is required.

17. A method according to claim 9, wherein the functionalized polymer is grown from a functionalized surface by atom transfer radical polymerization or nitroxide-mediated radical polymerization, and the planarized surface of the patterned media has a maximum variation of no more than 5 nm.

18. A method according to claim 9, further comprising providing the surface of the patterned media with an initiator, exposing the patterned media to a precursor for a selected period of time to grow the functionalized polymer directly on the surface based on a chemical reaction between the initiator and the precursor, removing the precursor to form the film on the surface, and removing a portion of the film until the surface is planarized.

19. A method according to claim 9, wherein the top surfaces of the magnetic elements are formed from a first material, and side walls of the magnetic elements and the gaps are formed from a second material, such that the functional group of the polymer grafts only to the side walls and gaps but not to the top surfaces to form the planarized surface without the removal step.

20. A magnetic media disk, comprising:
a substrate having an axis and concentric data tracks of magnetic elements, the concentric data tracks being separated from each other by radial gaps, the magnetic elements having top surfaces and the gaps having a gap surface that is axially spaced apart from the top surfaces of the magnetic elements, and the gaps are filled by a functionalized polymer such that the gaps are planarized and flush with the top surfaces.

21. A magnetic media disk according to claim 20, wherein each of the gaps have a width in a range of 1 to 100 nm, the functionalized polymer forms a monolayer film having a single molecular thickness in a range of 10% to 200% of the width of the gaps, and the top surfaces of the magnetic elements are exposed.

22. A magnetic media disk according to claim 20, wherein the functionalized polymer is one of a functionalized polystyrene, polymethyl methacrylate, polyethylene, polyethylene oxide, poly dimethylsiloxane, poly dihydroxybenzyl alcohol, and the functional group is one of a hydroxyl group, carboxilic group, thiol and methyl ester.

23. A magnetic media disk according to claim 20, wherein the functionalized polymer has a dendrimeric structure and at least one functional group

24. A magnetic media disk according to claim 20, wherein at least a portion of the functionalized polymer comprises a perfluoropolyether, and the magnetic elements are discrete track media (DTM) and the gaps comprise grooves that isolate the DTM from each other.

25. A magnetic media disk according to claim 20, wherein the magnetic elements are bit patterned media having individual bits formed in rows of nanometer-scale pillars that are separated from one another by the gaps, and the pillars in each row also are separated from each other in a transverse direction.
